(19) United States
(12) Patent Application Publication
(10) Pub. No.: US 2014/0190929 A1
(43) Pub. Date: Jul. 10, 2014

(54) SPRAY BOTTLE WITH IMPROVED GRIP

(71) Applicant: Impact Products, LLC, Toledo, OH (US)

(72) Inventors: John Thomas Irwin, Sylvania, OH (US); Stephen A. Dukes, North Baltimore, OH (US); Jeffrey C. Gayer, Sylvania, OH (US)

(21) Appl. No.: 14/147,112

(22) Filed: Jan. 3, 2014

Related U.S. Application Data
(60) Provisional application No. 61/748,922, filed on Jan. 4, 2013.

(51) Int. Cl. B05B 11/00

(52) U.S. Cl. CPC B05B 11/0037
USPC 215/384

(57) ABSTRACT

A bottle including a reservoir configured to contain a fluid therein. The bottle further including a grip portion in fluid communication with the reservoir. The grip portion has at least one of a textured surface substantially enveloping the grip portion and a plurality of annular indentations and a plurality of protrusions formed thereon.

This application claims priority to U.S. Provisional Patent Application Ser. No. 61/748,922 filed Jan. 4, 2013, hereby incorporated herein by reference in its entirety.

### FIELD OF THE INVENTION

The present invention relates to a bottle for dispensing a fluid including a grip portion configured to allow users having variable hand sizes to comfortably and effectively handle the bottle.

### BACKGROUND OF THE INVENTION

Bottles for dispensing fluid have been available for many years. Spray bottles can be used for dispensing various types of fluids, such as cleaning fluid, cosmetics, water, or other chemicals. Typically, spray bottles are configured to be handheld and include a pumping system to draw fluid from a reservoir. The pumping system may include a trigger mechanism for activating the pumping system and a nozzle for emitting fluid from the spray bottle. A common obstacle associated with spray bottles is the ability of users with varying hand sizes to equally and comfortably grip the spray bottle and effectively maneuver the spray bottle to efficiently dispense the fluid to a surface or media.

In order to facilitate ergonomic gripping and maneuverability, spray bottles commonly have a grip feature formed thereon. However, known grip features formed on spray bottles are limited for use during specific applications of fluids and do not accommodate a versatility of applications such as use of the spray bottle both with and without a pumping system and spray nozzle or for use with varying fluids. Additionally, the grip features of certain spray bottles must typically align with a direction of the nozzle of the pumping system to properly facilitate gripping and maneuverability. Furthermore, the grip features of spray bottles do not accommodate varying hand sizes for varying applications while minimizing manufacturing costs and complexity. There is a need for a bottle with a grip portion configured to ergonomically assist a user, militate against slipping, and accommodate varying hand sizes for a versatility of applications while minimizing a cost and complexity of manufacturing.

### SUMMARY OF THE INVENTION

Concordant and congruous with the present invention an improved bottle with a grip portion configured to ergonomically assist a user, militate against slipping, and accommodate varying hand sizes for a versatility of applications while minimizing a cost and complexity of manufacturing has surprisingly been discovered.

According to an embodiment, a bottle is disclosed. The bottle includes a reservoir configured to contain a fluid therein. The bottle further includes a grip portion in fluid communication with the reservoir. The grip portion has at least one of a textured surface substantially enveloping the grip portion and a plurality of annular indentations formed thereon.

According to another embodiment, a bottle including a reservoir configured to contain a fluid therein is disclosed. The bottle further includes a grip portion in fluid communication with the reservoir and having at least three annular indentations formed thereon and a plurality of protrusions interposed between each of the at least three annular indentations.

According to a further embodiment, a bottle is disclosed. The bottle includes a reservoir configured to contain a fluid therein. The bottle further includes a grip portion in fluid communication with the reservoir and having at least three annular indentations formed thereon and a textured surface formed on at least a portion thereof. Each of the at least three annular indentations having an outer diameter, the outer diameter of each of the at least three annular indentations increasing from a first end of the grip portion to a second end of the grip portion.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a top perspective view of a bottle according to an embodiment of the present invention;

FIG. 2 is a top perspective view of a bottle according to another embodiment of the present invention; and

FIG. 3 is a top perspective view of a bottle according to another embodiment of the present invention.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner.

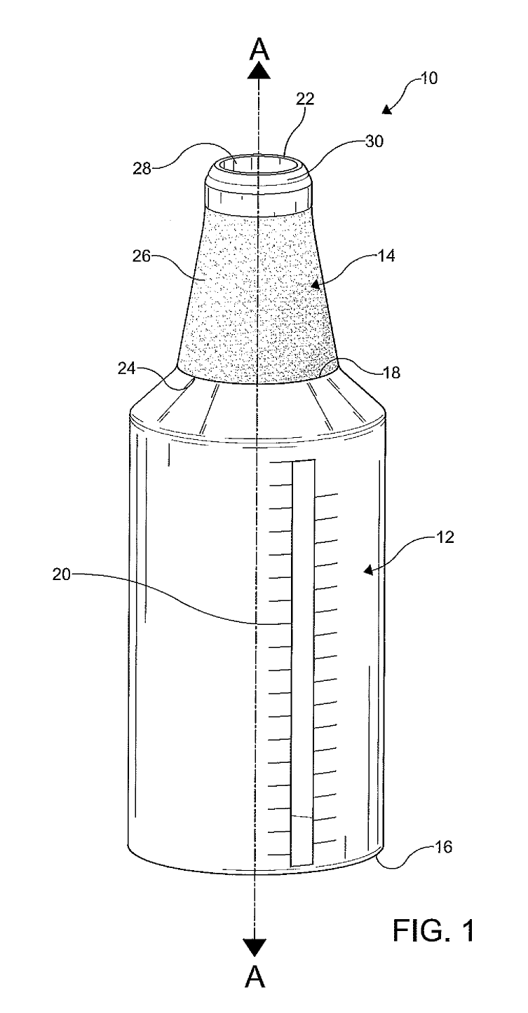

FIG. 1 illustrates a bottle 10 according to an embodiment of the invention. The bottle 10 includes a reservoir 12 for containing a fluid and a grip portion 14 for facilitating a grip by a user. The reservoir 12 is adjacent and integrally formed with the grip portion 14 to form a unitary structure. However, the grip portion 14 can be separately formed from the reservoir 12 and coupled thereto by any coupling means, such as a clamp, threaded fastener, snap-fit, or any other coupling means, as desired. The bottle 10 can be made from molded plastic materials, such as high-density polyethelene (HDPE), polymers, and the like. However, it is understood the bottle 10 can be made from any material as desired. For example, the bottle 10 can be made from glass, metal, or other fluid impermeable material.

The bottle 10 includes a longitudinal axis A extending through a longitudinal center thereof. The reservoir 12 has a closed reservoir end 16 for retaining fluids and an open reservoir end 18 for receiving fluids into the reservoir 12. The reservoir 12 is substantially cylindrical and concentric about the longitudinal axis A. However, the reservoir 12 can be any shape as desired such as cubical, conical, rectangular, or any other shape as desired. A portion of the reservoir 12 can taper inwardly towards the open reservoir end 18. The reservoir 12 may include indicia 20 disposed on a surface thereof to give a visual indication of an amount of fluid contained in the reservoir 12. The indicia 20 can correspond to a scale or gradient including graduations of millimeters, milliliters, or ounces, for example, although other graduations can be provided, as desired. The indicia 20 may be scribed on a surface of the reservoir 12 using any process for scribing, such as laser engraving, a rotary engraving, or an etching tool, or formed as a protuberance on the surface of the reservoir as desired.

The grip portion 14 is in fluid communication with the reservoir 12. The grip portion 14 is tubular and has a first end 22 and a second end 24. The second end 24 of the grip portion 14 abuts the open reservoir end 18 of the reservoir 12. The grip portion 14 is concentrically aligned with the longitudinal axis A of the bottle 10. The grip portion 14 has a truncated cylindrical shape wherein an outer diameter of the grip portion 14 increases along the longitudinal axis A such that the outer diameter of the grip portion 14 at the first end 22 thereof is less than the outer diameter of the grip portion 14 at the second end 24 thereof. Although, it is understood the grip portion 14 can have any shape as desired to facilitate a grip such as cylindrical, rectangular, ovular, planar, circular, or any other shape to facilitate a grip, for example.

The grip portion 14 further includes an opening 28 for receiving the fluid in the bottle 10 disposed thereon and adapted to receive a cap (not shown) or a pumping system (not shown) that may include a nozzle and/or a trigger mechanism for ejecting fluid out of the bottle 10. The grip portion 14 can include external threads 30 formed thereon and adapted for securing an internally threaded cap or pumping system. The opening 28 can be disposed at any position on the grip portion 14, as desired. For example, as shown in FIG. 1, the opening 28 is disposed at the first end 22 of the grip portion 14 and concentric with the longitudinal axis A of the reservoir 12. However, the opening 28 can be disposed anywhere on the grip portion 14 such as intermediate the first end 22 and the second end 24, for example.

The grip portion 14 has a textured surface 26 that is a grip feature for militating against slipping of a grip of the bottle 10. As illustrated in FIG. 1, the textured surface 26 extends from the second end 24 of the grip portion 14 towards the first end 22 and substantially envelopes the grip portion 14. The textured surface 26 can be mechanically or chemically disposed on an entirety of the grip portion 14 or disposed on a partial portion of the grip portion 14. The textured surface 26 can be textured by any surface roughening method as desired. For example, the textured surface 26 can be textured by embossing, stamping, punching, scratching, scoring, or any surface machining technique as desired. Additionally, the textured surface 26 can be formed with the grip portion 14 by a molding process, wherein the textured surface 26 is formed by a mold having the texture included thereon. Furthermore, the textured surface 26 can be separately applied to the grip portion 14. For example, the textured surface 26 can be a coating applied to the grip portion 14 such as a paint or an adhesive, for example.

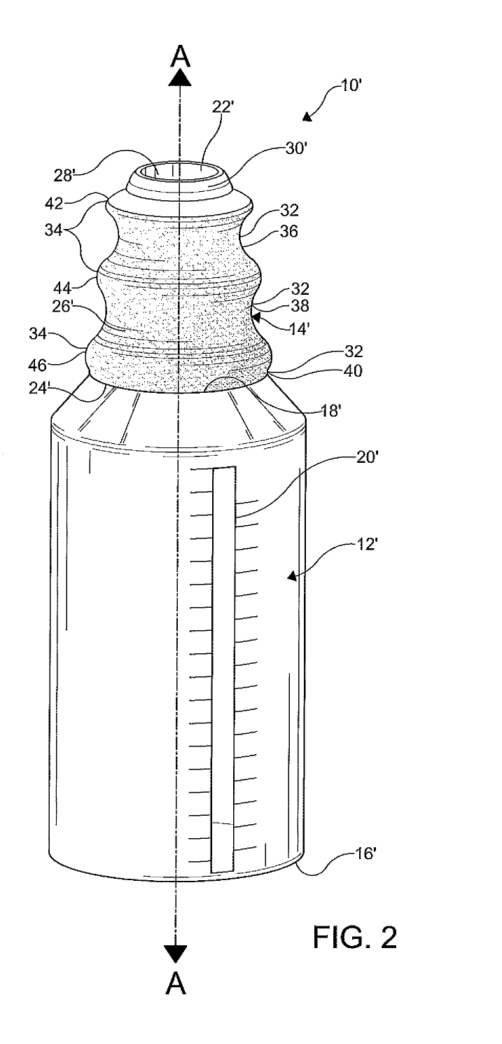

Referring now to the illustration in FIG. 2, a bottle 10′ according to another embodiment of the invention is illustrated. Structure similar to that illustrated in FIG. 1 includes the same reference numeral and a prime (′) symbol for clarity. The grip portion 14′ is in fluid communication with the reservoir 12′. The grip portion 14′ is tubular and has a first end 22′ and a second end 24′. The second end 24′ of the grip portion 14′ abuts the open reservoir end 18′ of the reservoir 12′. The grip portion 14′ is concentrically aligned with the longitudinal axis A′ of the bottle 10′. The grip portion 14′ has a curvilinear shape, wherein an outer diameter of the grip portion 14′ increases along the longitudinal axis A′

In the embodiment illustrated in FIG. 2, the grip portion 14′ has a plurality of spaced apart annular indentations 32 formed on the grip portion 14′ of the bottle 10′, thereby forming a plurality of spaced apart annular protrusions 34 interposed therebetween. Each of the indentations 32 and the protrusions 34 are concentrically disposed along the longitudinal axis A′ of the reservoir 12′. Each of the plurality of indentations 32 is adapted to receive a finger of a user (not shown). As illustrated, each of the indentations 32 and the protrusions 34 are arcuate to correspond to the shape of the fingers of the user. However, the protrusions 34 can be any shape as desired such as substantially planar, for example.

The grip portion 14′ can have any number of indentations 32 and protrusions 34 formed thereon, as desired. For example, as illustrated in the embodiment, the grip portion 14′ can have a first indentation 36, a second indentation 38, a third indentation 40, a first protrusion 42, a second protrusion 44, and a third protrusion 46. The first protrusion 42 is disposed adjacent the first end 22′ of the grip portion 14′. The first indentation 36 is disposed intermediate the first protrusion 42 and the second protrusion 44. The second indentation 38 is disposed intermediate the second protrusion 44 and the third protrusion 46. The third indentation 40 is disposed intermediate the third protrusion 46 and the reservoir 12′. However, it is understood the grip portion 14′ can have any number of indentations 32 and protrusions 34 as desired such as more than three indentations 32 and more than three protrusions 34.

The outer diameter of the grip portion 14′ at each of the protrusions 42, 44, 46 varies, wherein the grip portion 14′ at the first protrusion 42 has an outer diameter less than the grip portion 14′ at the second protrusion 44 and an outer diameter of the grip portion 14′ at the third protrusion 46. Additionally, the outer diameter of the grip portion 14′ at the second protrusion 44 is less than the outer diameter of the grip portion 14′ at the third protrusion 46. Likewise, an outer diameter of the grip portion 14′ at each of the indentations 36, 38, 40 varies, wherein the grip portion 14′ at the first indentation 36 has an outer diameter less than an outer diameter of the grip portion 14′ at the second indentation 38 and an outer diameter of the grip portion 14′ at the third indentation 40. Additionally, the outer diameter of the grip portion 14′ at the second indentation 38 is less than the outer diameter of the grip portion 14′ at the third indentation 40. However, the outer diameter of the grip portion 14′ at each of the protrusions 42, 44, 46 and each of the indentations 36, 38, 40 can be any dimension as desired. For instance, the outer diameter of the grip portion 14′ at each of the indentations 36, 38, 40 can be equal and the outer diameter of the bottle grip portion 14 at each of the protrusions 42, 44, 46 can be equal.

The grip portion 14′ has a textured surface 26′ that is a grip feature for militating against slipping of a grip of the bottle 10′. As illustrated in FIG. 2, the textured surface 26′ extends from the second end 24′ of the grip portion 14′ towards the first end 22′ and substantially envelopes the grip portion 14′. The textured surface 26′ can be mechanically or chemically disposed on an entirety of the grip portion 14′ or disposed on a partial portion of the grip portion 14′. In a non-limiting example, the textured surface 26′ can be partially disposed on each of the indentations 32, wherein the protrusions 34 have a substantially smooth surface. The textured surface 26′ can be textured by any surface roughening method as desired. For example, the textured surface 26′ can be textured by embossing, stamping, punching, scratching, scoring, or any surface machining technique as desired. Additionally, the textured surface 26′ can be formed with the grip portion 14′ by a molding process, wherein denthereon. Furthermore, the textured surface 26′ can be separately applied to the grip portion 14′. For example, the textured surface 26′ can be a coating applied to the grip portion 14′ such as a paint or an adhesive, for example.

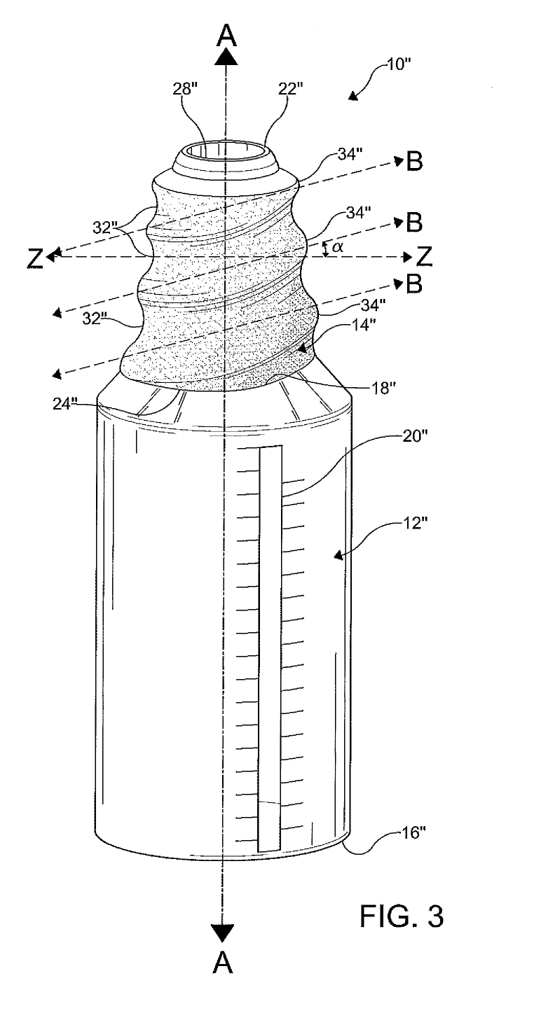

Referring now to the illustration in FIG. 3, a bottle 10″ according to an embodiment of the invention is illustrated. Structure similar to that illustrated in FIG. 1 and FIG. 2 includes the same reference numeral and a double prime (″) symbol for clarity. The grip portion 14″ is tubular and has a first end 22″ and a second end 24″. The second end 24″ of the grip portion 14″ is disposed adjacent the open reservoir end 18″ of the reservoir 12″. The grip portion 14″ is concentrically aligned with the longitudinal axis A″ of the reservoir 12″ and is in fluid communication with the reservoir 12″. The grip portion 14″ has a curvilinear shaped surface. An outer diameter of the grip portion 14″ at each of the indentations 32″ and an outer diameter of the grip portion 14″ at each of the protrusions 34″ varies along the longitudinal axis A″ from the first end 22″ to the second end 24″ thereof.

In the embodiment illustrated in FIG. 3, the grip portion 14″ has the plurality of spaced apart, substantially annular indentations 32″ formed on the grip portion 14″ of the bottle 10″, thereby forming the plurality of spaced apart, substantially annular protrusions 34″ interposed therebetween, similar to the grip portion 14″ illustrated in FIG. 2. Each of the plurality of indentations 32″ is adapted to receive fingers of a user (not shown). As illustrated, each of the indentations 32″ and each of the protrusions 34″ are arcuate to correspond to the shape of the fingers of the user. However, the protrusions 34″ can be any shape as desired such as substantially planar, for example.

The protrusions 34″ are oriented along a plurality of orientation axes B, as shown in FIG. 3. Each of the orientation axes B are parallel to each other and are oriented at an angle α with respect of a transverse axis Z perpendicular to the longitudinal axis A″. For example, the angle α can be any angle such as 30 degrees, 15 degrees, 10 degrees or any other angle with respect of the transverse axis Z, as desired. The indentations 32″ are interposed between the protrusions 34″ and are also oriented parallel to each other and oriented at the angle α with respect of the transverse axis Z. It is understood, each of the indentations 32″ and the protrusions 34″ can be arranged along a plurality of orientation axes oriented at varying angles with respect of the transverse axis Z, as desired. For example, the first protrusion 42″ can be arranged along an orientation axis oriented at a first angle with respect of the transverse axis Z, the second protrusion 44″ can be arranged along an orientation axis oriented at a second angle with respect of the transverse axis Z, and the third protrusion 46″ can be arranged along an orientation axis oriented at a third angle with respect of the transverse axis Z. Furthermore, the protrusions 34″ can be a single protrusion helically wound on a surface of the grip portion 14″ about the longitudinal axis A′, wherein a diameter of the grip portion 14″ at the single protrusion increases from the first end 22″ to the second end 24″ thereof.

The grip portion 14″ has a textured surface 26″ that is a grip feature for militating against slipping of a grip of the bottle 10″. As illustrated in FIG. 3, the textured surface 26″ extends from the second end 24″ of the grip portion 14″ towards the first end 22″ and circumscribes the grip portion 14″. The textured surface 26″ can be mechanically or chemically disposed on an entirety of the grip portion 14″ or disposed on a partial portion of the grip portion 14″. In a non-limiting example, the textured surface 26″ can be partially disposed on each of the indentations 32″, wherein the protrusions 34″ have substantially smooth surface. The textured surface 26″ can be textured by any surface roughening method as desired. For example, the textured surface 26″ can be textured by embossing, stamping, punching, scratching, scoring, or any surface machining technique as desired. Additionally, the textured surface 26″ can be formed with the grip portion 14″ by a molding process, wherein the textured surface 26″ is formed by a mold having the texture included thereon. Furthermore, the textured surface 26″ can be separately applied to the grip portion 14″. For example, the textured surface 26″ can be a coating applied to the grip portion 14″ such as a paint or an adhesive, for example.

In application, the bottle 10, 10′, 10″ can be used for containing and dispensing a fluid such as a fluid used for cleansing or sterilizing surfaces, dispensing cosmetics, or to apply any fluid to a surface or media, as desired. To use, a user positions fingers on the grip portion 14, 14′, 14″ and grips the grip portion 14, 14′, 14″ so the user can both comfortably hold the bottle 10, 10′, 10″ and maneuver the trigger mechanism of the pumping system attached thereto to dispense the fluid contained in the reservoir 12, 12′, 12″. Where indentations 32, 32″ are included on the grip portion 14′, 14″, the user can positions at least one finger on at least one of the indentions 32, 32″ and grip the grip portion 14′, 14″ so the user can both hold the bottle 10′, 10″ and maneuver the trigger mechanism of the pumping system attached thereto to dispense the fluid contained in the reservoir 12, 12′, 12″ to a surface or media. The textured surface 26, 26′, 26″, the indentations 32, 32″, and the protrusions 34, 34″ facilitate a non-slip and ergonomic grip of the bottle 10, 10′, 10″ for any application. The grip portion 14, 14′, 14″ can be used to facilitate ergonomic gripping of the bottle 10, 10′, 10″ used with or without a pumping system. Additionally, the textured surface 26, 26′, 26″, the indentations 32, 32″, and the protrusions 34, 34″ facilitate ergonomic maneuvering of the bottle 10, 10′, 10″ regardless of the orientation of the bottle 10, 10′, 10″ and regardless of the position of the nozzle of the pumping system received in the bottle 10, 10′, 10″. Where indentations 32″ and protrusions 34″ are arranged on the grip portion 14″ at the angle α with respect of the transverse axis Z, the bottle 10″ can be efficiently maneuvered for use in applications in which the bottle 10″ is required to be positioned at an angle with respect to the application surface or media.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A bottle, comprising:
a reservoir configured to contain a fluid therein; and
a grip portion in fluid communication with the reservoir and having at least one of a textured surface substantially enveloping the grip portion and a plurality of annular indentations formed thereon.

2. The bottle of claim 1, wherein the grip portion includes a first end and a second end, the first end having an opening configured to receive at least one of a cap and a pumping system and the second end abutting the reservoir.

3. The bottle of claim 1, wherein an outer diameter of the grip portion increases from a first end to a second end thereof.

4. The bottle of claim 1, wherein the grip portion includes the textured surface and the textured surface is one of mechanically formed on the grip portion and chemically formed on the grip portion.

5. The bottle of claim 1, wherein the grip portion includes the plurality of annular indentations and each of the plurality of annular indentations is adapted to receive a finger.

6. The bottle of claim 1, wherein the grip portion includes the plurality of annular indentations and the plurality of annular indentations include at least three annular indentations.

7. The bottle of claim 6, wherein an outer diameter of a first one of the annular indentations is less than an outer diameter of a second one of the annular indentations, and an outer diameter of a third one of the annular indentations is greater than the outer diameter of the second one of the annular indentations.

8. The bottle of claim 1, wherein the grip portion includes the plurality of annular indentations and an outer diameter of each of the plurality of annular indentations increases from a first end of the grip portion to a second end of the grip portion.

9. The bottle of claim 1, wherein the grip portion includes the plurality of annular indentations and further comprises a plurality of protrusions interposed between each of the plurality of annular indentations.

10. The bottle of claim 9, wherein an outer diameter of each of the plurality of protrusions increases from a first end of the grip portion to a second end of the grip portion.

11. The bottle of claim 1, wherein the grip portion includes both the plurality of annular indentations and the textured surface.

12. The bottle of claim 1, wherein the grip portion includes the plurality of annular indentations and the plurality of annular indentations is formed at an angle with respect to a transverse axis of the bottle.

13. The bottle of claim 12, wherein the angle is 30 degrees.

14. A bottle, comprising:
a reservoir configured to contain a fluid therein; and
a grip portion in fluid communication with the reservoir and having at least three annular indentations formed thereon and a plurality of protrusions interposed between each of the at least three annular indentations.

15. The bottle of claim 14, wherein an outer diameter of a first one of the annular indentations is less than an outer diameter of a second one of the annular indentations, and an outer diameter of a third one of the annular indentations is greater than the outer diameter of the second one of the annular indentations.

16. The bottle of claim 14, wherein an outer diameter of each of the plurality of annular indentations and an outer diameter of each of the plurality of protrusions increases from a first end of the grip portion to a second end of the grip portion.

17. The bottle of claim 14, wherein the grip portion includes a textured surface formed on at least a portion thereof.

18. The bottle of claim 14, wherein the plurality of annular indentations is formed at an angle with respect to a transverse axis of the bottle.

19. The bottle of claim 14, wherein each of the at least three annular indentations is adapted to receive a finger.

20. A bottle, comprising:
a reservoir configured to contain a fluid therein; and
a grip portion in fluid communication with the reservoir and having at least three annular indentations formed thereon and a textured surface formed on at least a portion thereof, each of the at least three annular indentations having an outer diameter, the outer diameter of each of the at least three annular indentations increasing from a first end of the grip portion to a second end of the grip portion.
